(19) United States
(12) Patent Application Publication
(10) Pub. No.: US 2003/0033225 A1
(43) Pub. Date: Feb. 13, 2003

(54) Multi-dimensional accounting engine

(76) Inventor: Robert Allen Meldahl, Bedminster, NJ (US)

Correspondence Address: Robert Meldahl, 56 Wentworth Rd., Bedminster, NJ, 07921, US

(21) Appl. No.: 09/924,704

(22) Filed: Aug. 9, 2001

(51) Int. Cl. G06F 17/60

(52) U.S. Cl. 705/30

(57) ABSTRACT

The current invention is a software apparatus for journaling accounting transactions into a multi-dimensional data structure and for extracting those transactions from the multi-dimensional data structure and generating ledger accounts, balance statements and the other components of the Generally Accepted Accounting Principles (GAAP).

A user either enters an acounting journal entry directly into the Multi-dimensional Accounting Engine or indirectly from another program or external file. The Multi-dimensional Accounting Engine converts the entry from its flat (without dimension) form into a multi-dimensional data structure such as the data structures prevalent in data warehousing. The user can then use the Multi-dimensional Accounting Engine to, on demand, generate ledger acounts, balance sheets and financial statements. All of the recommendations of the GAAP can be generated dynamically using this invention.

### CROSS-REFERENCE TO RELATED APPLICATIONS

Not Applicable.

### BACKGROUND

1. Field of Invention

This invention relates to general accounting principles and computer software. It will most likely be classified in Class 705, in either Subclass 10 or Subclass 30.

2. Description of Prior Art

Various accounting software applications have been developed and marketed. However, all of these applications have followed the conventional model that has dominated the accounting profession for over five-hundred years. According to that model, each business transaction is recorded in three different places. The transaction is entered once in a journal (an historical record of all transactions) and then it is entered in two accounts in the general ledger. In one of the general ledger accounts it is recorded as a debit and in the second general ledger account it is recorded as a credit. The accounts in the general ledger are then treated as the primary source of transaction information in accounting, with the journal being used primarily as a backup to the general ledger accounts.

The Multi-dimensional Accounting Engine takes a revolutionary new approach to accounting. It treats the journal itself as the sole source of information for generating accounting reports and does not even enter the information in general ledger accounts. It treats the general ledger as a useless vestige of the “paper and pencil” days and recognizes that it serves no useful purpose in electronic data processing.

In the conventional accounting practice, the general ledger accounts serve the purpose of categorizing the business transaction. In the Multi-dimensional Accounting Engine this categorization is performed through the dimensions in the underlying multi-dimensional data structure. A dimension in a computer data structure is an index that is used to access a piece of data. In a single dimension data structure an index of 4 accesses the fourth element in the row that makes up the single dimension. In a two dimensional data structure, the row index of 6 and the column index of 8 accesses the eighth element of the sixth row in the two dimensions that make up the data structure. Any number of dimensions can be given to the data. In the Multi-dimensional Account Engine, the function performed by the ledger accounts is satisfied by dimensions. Each transaction has a debit dimension, a credit dimension, a calendar date dimension, and a description dimension, as well as any number of other dimensions that the business uses to categorize the transaction.

This revolutionary multi-dimensional approach to accounting makes the Mulit-dimensional Accounting Engine a unique invention that has no precedent in the business world.

A database search of the United States Patents was made and a large number of U.S. patents were analyzed. No patent was found that conflicted with the current invention. The following is a list of those patents that had something in common with the current invention, although none of these patents approximated the intent, scope and purposes of the current invention:

1. U.S. Pat. No. 5,974,396 entitled, “Method and system for gathering and analyzing consumer purchasing information based on product and consumer clustering relationships”. This invention is a system for tracking the buying habits of consumers and creating direct advertisements that are sent to individual consumers based on the consumers' past purchases. A database is used to store information on the consumers and each consumer is associated with at least one product cluster. Specific consumers are then targeted according to the cluster information. Although this invention provides the user with an analysis of consumer information, it performs this function by clustering data. The Multi-dimensional Accounting Engine provides this analytical information by “slicing” or combining the data along one or more of the data's many dimensions. Furthermore, the Multi-dimensional Accounting Engine is primarily intended for journaling accounting transactions and its ability to analyze customer behavior is ancillary to its primary function.

2. U.S. Pat. No. 5,740,427 entitled, “Modular automated account maintenance system”. An accounting system that is directed towards small businesses. The system processes predefined business transactions. Each transaction contains a core part and an auxiliary part. The core part defines a specific accounting process and the auxiliary part contains data specific to the transaction. The two parts are assigned the same unique identifier number and then stored in two different storage mediums. Any transaction can then be retrieved and reassembled using the unique identifier number. The core part defines which accounts are affected by the transaction and generates updates to those accounts. In actuality, this patent has nothing in common with the Multi-dimensional Accounting Engine other than the fact that it is a tool used for the accounting practice. It does not use a multi-dimensional data structure and so does not use the analytical powers of dimensional slicing in order to dynamically generate the accounting reports.

3. U.S. Pat. No. 5,875,435 entitled, “Automated accounting system”. A business accounting system that allows transactions to be input at various remote locations and further allows access to the system by an agent of the business, such as an accountant, who is also at a remote location. The system provides a menu of financial transactions and itemization codes to facilitate the input of data. The system is used to prepare and print income, expense, assets and liability statements. Again, this patent only relates to the Multi-dimensional Accounting Engine in that they both are used for accounting purposes and generate accounting reports. It does not use the multi-dimensional data structure that the Multi-dimensional Accounting Engine does and does not offer the analytical power that the Multi-dimensional Accounting Engine does in generating accounting reports and other information creating reports.

4. U.S. Pat. No. 6,026,397 entitled, “Data analysis system and method”. A customer analysis system that assigns customers to demographic groups according to similar characteristics. The demographic groups are analyzed to predict customer behavior based upon past customer behavior, product preference, and propensity to respond to direct mailings

### SUMMARY

In accordance with the present invention a complete accounting system can be managed by a single software engine that accepts business transactions and produces, at the user's request, all of the standard accounting reports. The accounting reports are produced from an underlying data structure that categorizes data in any number of dimensions. Each dimension represents a different way of categorizing the transaction. Implicit in this model are the four dimensions necessary for the accounting process, the debit dimension, the credit dimension, the calendar date dimension, and the description dimension.

### OBJECTS AND ADVANTAGES

The objects and advantages of the present invention are:

1. All the accounting and bookkeeping functions of a business are reduced to the minimal effort of simply recording each business transaction. Once the business transaction is recorded in the engine, all the accounting reports are performed automatically using the multi-dimensional aspects of the stored data.

2. The Multi-dimensional Accounting Engine can be configured to maintain any number of additional dimensions besides the standard accounting dimensions of the debit account, the credit account, and the time. Each additional dimension offers the business a different way to categorize the business transactions for the purpose of market analysis, expense tracking, and other interesting ways of forming information.

3. Accounting reports can be dynamically generated as needed, rather than periodically (e.g., quarterly income statements). Furthermore, the user can specify the range of time used in the analysis (e.g., an income statement can be generated for the time frame of Jun. 15, 2001 to Jul. 20, 2001).

4. Since general ledger accounts do not have any real existence in the Multi-dimensional Accounting Engine there is no duplication of data, a practice that is inherently dangerous and causes information systems to become inconsistent and conflicting. It is important to note that general ledger accounts can be generated dynamically as reports if the user desires them).

Because of the additional power that the multi-dimensional data model lends to the practice of accounting, the Multi-dimensional Accounting Engine can provide businesses with the analytical power to maintain inventory, design market approaches and predict future earnings in addition to what is currently accomplished by existing accounting paradigms.

### DESCRIPTION—MAIN EMBODIMENT

The main embodiment of the present invention is illustrated in FIGS. A1 and A2. FIG. A1 introduces the concept of a multi-dimensional data structure to the reader. It is this data structure that lies at the heart of the invention and therefore should be understood clearly by the reader. FIG. A2 is the real static description of the Multi-dimensional Accounting Engine.

FIG. A1 is a diagram of a typical multi-dimensional data structure. If implemented in a realtional database each box in the figure would be a table (the multi-dimensional data structure can be implemented in another form other than a relational database).

The primary characteristic of the design in FIG. Al is its “star” shape. This is referred to as a “star schema”. There is typically a single table in the center, referred to as a “fact” table, surrounded by a number of dimensional tables. In FIG. A1, the fact table is represented by the box number 2. The dimension tables are represented by the boxes numbered 6, 8, 10, 12, 14, and 16. Each record in the fact table contains one or more amount fields (e.g., the amount of the business transaction) and a reference (or index) to a record in each of the dimension tables. A record in the fact table may have an amount of one-hundred dollars and an index to the record in the credit dimension that represents the “Cash” account and an index to a record in the debit dimension that represents the “Office Furniture” account. Further indexes in the fact record would reference records in the remaining dimension tables. Groups of the dimensions can be used in combination with each other to categorize the transactions in the fact table.

FIG. A2 is an illustration of the static specification of this invention. Each box in FIG. A2 is a software component representing one or more objects, in the inventions object-oriented architecture. Each component is named and numbered and given a short description.

Central to FIG. A2 is the component named the Dimensional Transformer (numbered 100 in FIG. A2). This component converts conventional, non-dimensional data, typical of accounting journal entries, into data that has dimensions and is ready to be loaded into the underlying multi-dimensional data structure. The data that is input into this component has a monetary amount (as do all accounting transactions) as well as the name of the account that is debited by the transaction and the name of the account that is credited by the transaction and the date of the transaction. The Dimensional Transformer component (100) is responsible for converting the name of the debit account to an index number in the debit dimension of the multi-dimensional data structure. It also is responsible for making this same conversion of the name of the credit account to an index in the credit dimension. Any additional dimensions are handled the same way by the Dimensional Transformer (100) component.

The user is free to define his own definitions for the input data and is free to define the dimensions of the underlying data structure. The Dimensional Transformer (100) is configured with both definitions and how they are mapped to each other before the journal entries are entered. The definitions of the input data is given to the Dimensional Transformer (100) by one of the two input components, either the User Interface component (210) or the Bulk Loader component (220). The definition of the underlying multi-dimensional data structure is read in from an external file.

The User Interface component (210) is used by a user that enters transactions through a Graphical User Interface (GUI) or window environment. The Bulk Loader component (220) first passes a definition of its input data to the Dimensional Transformer (100). It then begins to pass large numbers of journal entries, in bulk, to the Dimensional Transformer (100).

The Star component (300) contains a structure that is isomorphic with the underlying data structure. For each dimension in the underlying data structure there is a dimensional component that is managed by the Star component. Examples of these dimensional components are the Debit component (310), the Credit component (320), the Calendar Date component (330), and the Description component (340). Each of these dimensional components know how to convert input data into an index into the corresponding dimension in the underlying data structure. The Dimensional Transformer component (100) uses these dimensional components to actually perform the transformation of the individual dimension.

The Data Module component (500) is the software entity that manages the underlying multi-dimensional data structure. It is a “plug-and-play” interchangeable component that can be replaced by other versions that allow the underlying data structure to be implemented as a relational database or other alternative.

The components numbered 510, 520, and 530 are logically simple components that use the multi-dimensional aspects of the Data Module component (500) to produce accounting reports. There are additional modules of this sort that satisfy all the practices recommended by the Generally Accepted Accounting Principles (GAAP).

The Dicer component (580) is a module that allows the non-technical user to dynamically piece together dimensions in order to make an ad hoc analyitical study. The Slicer component (590) allows a user to choose between a number of pre-written analytical studies that have been developed by the user at an earlier time and that are stored with the Multi-dimensional Accounting Engine.

### DRAWING FIGURES

FIG. A1

2 Fact table

6 Debit dimension table

8 Credit dimension table

10 Date dimension table

12 Customer dimension table (optional)

14 Description dimension table

16 Supplier dimension table (optional)

FIG. A2

100 Dimensional Transformer component

210 User Interface component

220 Bulk Loader component

300 Star component

310 Debit dimension component

320 Credit dimension component

330 Time dimension component

340 Description dimension component

500 Data Module component

510 Ledger Account component

520 Balance Sheet component

530 Income Statement component

580 Dicer component

590 Slicer component

FIG. B1

1010 Configuring the Star step

1020 User Interface configuration step

1030 Bulk Loader configuration step

1100 User Interface data input step

1110 Bulk Loader data input step

1120 Data transformation step

1130 Debit dimension index resolution step

1140 Data storage step

FIG. B2

2110 Ledger account request step

2120 Balance sheet request step

2130 Income statement request step

2140 Analysis request step

2210 Ledger account generation step

2220 Balance sheet generation step

2230 Income statement generation step

2240 Analysis generation step

2300 Dimensional transformation step

2310 Debit dimension resolution step

2400 Data retrieval step

### OPERATION—MAIN EMBODIMENT

This invention is operated from two perspectives, the perspective of the user who enters or journals business transactions (FIG. B1) and the perspective of the user who is using the invention to generate an accounting report or some other analytical study (FIG. B2).

Starting from the top of FIG. B1 and proceeding downward, we see that the Multi-dimensional Accounting Engine starts up and reads in a complete definition of the structure of the underlying database (1010). The Star component (300 in FIG. A2) is constructed with all of the definitions that exist in the database. After this operation, the Multi-dimensional Accounting Engine is prepared to work with any module that attempts to enter business transactions.

In (1020) and (1030) we see the data entry modules begin to insert transactions. The User Interface component (210 in FIG. A2) and the Bulk Loader component (220 in FIG. A2) begin by sending the structures of their input data and a mapping of how this data relates to the underlying database structure. Both input components have knowledge of the Star component and contain mappings from their input to the dimensions of the Star component. At this point in time the Dimension Transformer (100 in FIG. A2) has all of the information necessary to convert the input to a multi-dimensional form.

With all of the data definitions given to the Dimensional Transformer component. the input modules (210 and 220 in FIG. A2) begin to send their transactions to the Dimensional Transformer component. This is shown in steps 1100 and 1110 of FIG. B1.

In step 1120 of FIG. B1 we see the Dimensional Transformer component convert the data from plain text to a fact record containing a set of dimensional indexes.

In step 1130 of FIG. B1 we see the Dimensional Transformer component taking the name of the debit account as text and sending it to the Debit Dimension component (310 in FIG. A2). This Debit Dimension component contains a mapping from the set of allowed text entries (the names of all the accounts) to the indexes that represent them in the debit dimension of the underlying database. The Debit Dimension component finds the proper index and returns it to the Dimensional Transformer component then adds adds the index to the Multi-dimensional fact record that it is building.

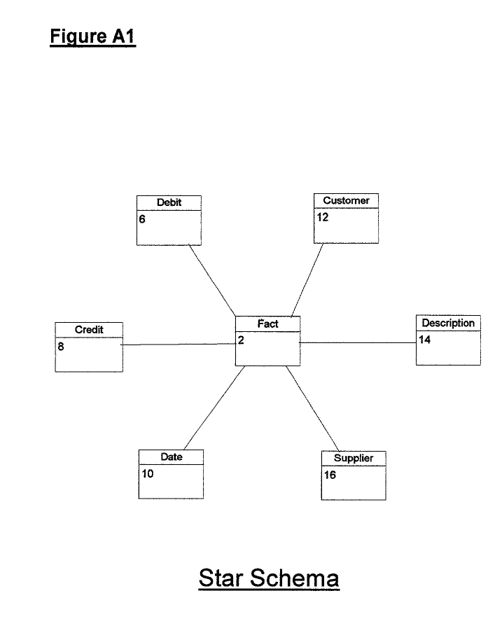

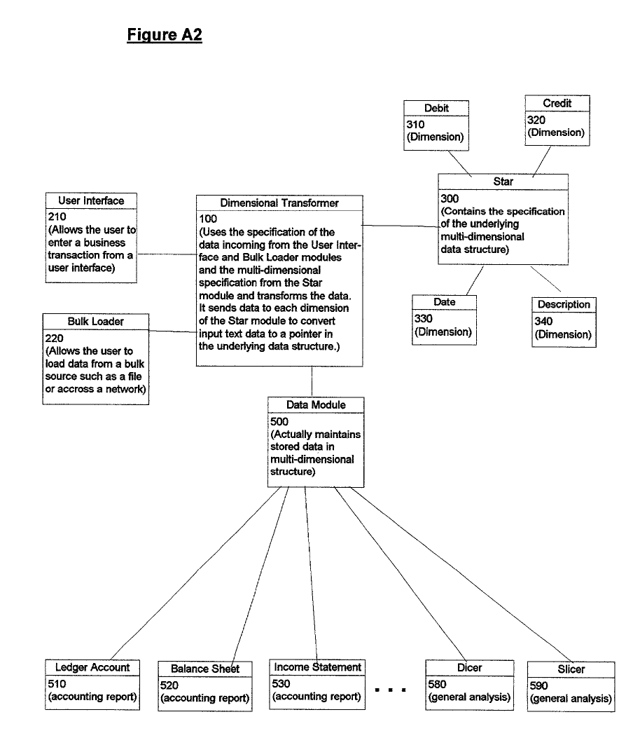

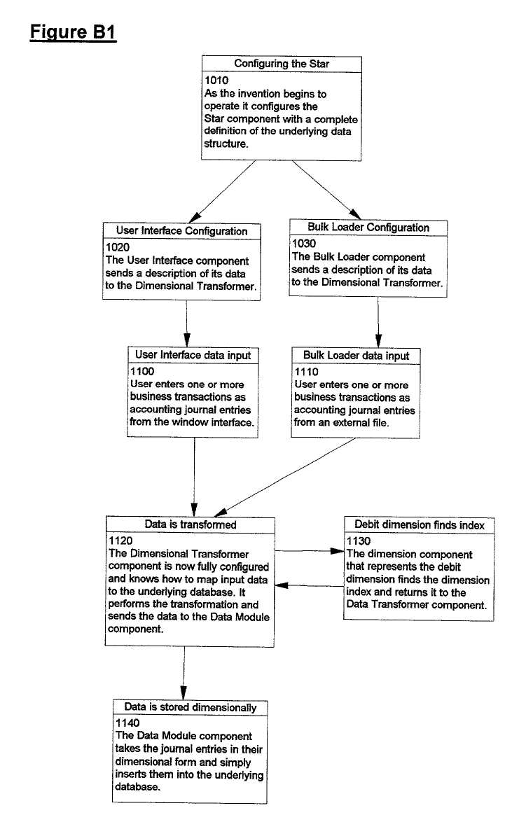

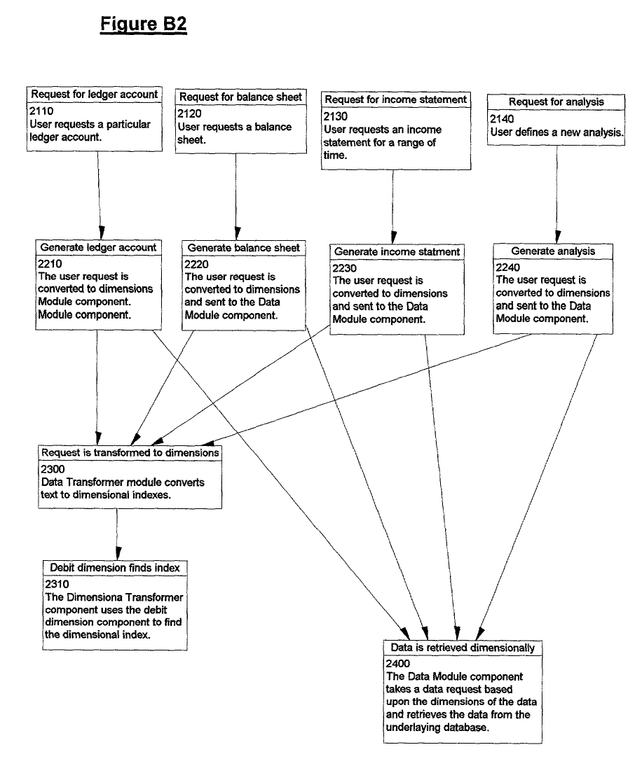

The Dimensional Transformer component does this for each dimension in the database. When all the dimensions are resolved the Dimensional Transformer component sends the new multi-dimensional fact record to the Data Module component (FIG. 500 in FIG. A2) where the fact record is added to the underlying data structure. At this point, the journaling of new transactions in the multi-dimensional database is complete.

At the top of that FIG. B2, we see a set of boxes numbered 2110, 2120, 2130, and 2140. Each of these boxes represent the input of a user request for analytical data. The user goes through the graphical user interface to build a request and then sends the request to an appropriate module within the Mulit-dimensional Accounting Engine (this is shown in boxes numbered 2210, 2220, 2230, and 2240 of FIG. B2). In box 2210 the request goes to component 510 of FIG. A2. In box 2220 the request goes to component 520 of A2. In box 2230 the request goes to component 530 of FIG. A2. In box 2240 the request goes to component 580 or component 590 of FIG. A2.

All of the requests are made in terms of user's text and are meaningless in terms of the underlying data structure which needs to be addressed in terms of dimension indexes rather than text. The requests are all sent to the Dimensional Transformer component (100 in FIG. A2). In the Dimensional Transformer component the textual requests are transformed by use of the Dimension software components (310, 320, 330, 390 in FIG. A2) into dimensional indexes. This is shown in steps 2300 and 2310 of FIG. B2.

The Dimensional Transformer returns the request, in dimensional form, back to the requesting component which then sends the request to the Data Module component (500 in FIG. A2). This is shown in step 2400 of FIG. B2. The Data Module component accesses the underlying database and returns the results back to the requesting component where they are eventually returned to the requesting user.

### ADVANTAGES

From the description above, a number of advantages of this invention become evident:

1. All accounting reports can be created dynamically upon the user's request.

2. Unlike a conventional accounting journal, which relates a transaction to a debit account and a credit account, a multi-dimensional data structure allows each entry to be stored with any amount of additional information, allowing the accountant to create an analysis tool that far exceeds the limites of today's current accounting practices.

3. Within a multi-dimensional data structure the journal entries can readily by used for other analytical studies.

4. Acounting reports can be limited to any range of dates that the user is interested in.

5. Ledger accounts are generated dynamically from the multi-dimensional data structure and have no physical existence of their own. This avoids a duplication of data between the journal and the ledger accounts and the consistency problems that are inherent in duplicated data.

6. Simplicity. The bookkeeping staff only has to enter the transactions into the Multi-dimensional Accounting Engine and the said Multi-dimensional Accounting Engine automatically performs all the other accounting processes.

### CONCLUSION, RAMIFICATIONS, AND SCOPE

Accordingly, the reader will see that the Multi-dimensional Accounting Engine gives businesses the ability to perform their accounting chores by simply journaling the transaction. All the accounting work other then the actual journaling itself is performed automatically by the Multi-dimensional Accounting Engine.

The complete accounting practice, according to the General Accepted Accounting Principles (GAAP) can be performed effortlessly by the Multi-dimensional Accounting Engine and the underlying dimensional data structure. The only bookkeeping effort required is to journal the actual business transactions.

The underlying multi-dimensional data structure can be used for other analytical reports which break the transactions down by customer demographics and other market factors.

I claim:

1. A software machine for maintaining accounting journal entries in a multi-dimensional data structure and using these entries to generate the financial statements governed by the Generally Accepted Accounting Practices (GAAP). The multi-dimensional data structure is typically, but not limited to, a relational database where the amount of the journal entry is connected to a set of indexes, including but not limited to:
An index that relates the journal entry to a debit account,
An index that relates the journal entry to a credit account,
An index that relates the journal entry to a calendar date, and
An index that relates the journal entry to an entry description.
This software machine comprises:
a. The means of converting standard journal entries into a Multi-dimensional (indexed) data structure,
b. The means to generate ledger accounts from the said Multi-dimensional data structure,
c. The means to generate balance sheets from the said Multi-dimensional data structure,
d. The means to generate income statements from the said Multi-dimensional data structure,
e. The means to generate statements of owner's equity from the said multi-dimensional data structure,
f. The means to generate retained earnings statements from the said multi-dimensional data structure,
g. The means to generate statements of cash flow from the said Multi-dimensional data structure,
h. The means to generate all other financial statements governed by the said GAAP from the said multi-dimensional data structure,
whereby the only data that needs to be stored and maintained by and for the software machine are:
The monetary amounts of the journal entries,
The indexes that relate the journal entries to the dimensions (the debit account dimension, the credit account dimension, the calendar date dimension, and the entry description dimension),
And the data structures that contain the actual dimensions (e.g., the debit account dimension would contain detailed information about each possible debit account).
